(19) United States
(12) Patent Application Publication
(10) Pub. No.: US 2026/0318762 A1
(43) Pub. Date: Oct. 15, 2026

(54) Sensor Arrangement for Determining a Torsion Angle of a Torsion Bar, Steering Device of a Motor Vehicle, Motor Vehicle, Method for Operating a Sensor Arrangement

(71) Applicant: Robert Bosch GmbH, Stuttgart (DE)

(72) Inventors: Michael Kleinknecht, Lehrensteinsfeld (DE); Sina Fella, Neuenstadt (DE); Stefan Kuntz, Flein (DE)

(21) Appl. No.: 19/104,224

(22) PCT Filed: Jun. 27, 2023
(86) PCT No.: PCT/EP2023/067422

§ 371 Date: Feb. 16, 2025

(30) Foreign Application Priority Data
Aug. 25, 2022 (DE) 10 2022 208 796.8

(51) Int. Cl. G01L 5/22; G01L 3/10

(52) U.S. Cl. CPC G01L 5/221; G01L 3/105

(57) ABSTRACT

A sensor arrangement for determining a torsion angle of a torsion bar, in particular a steering device of a motor vehicle, has at least one first, second and third, in particular in each case flat or disc-shaped, substrate, which are spaced apart from one another on the torsion bar and are each connected to the torsion bar in a rotationally fixed manner. The third substrate is arranged between the first substrate and the second substrate in the longitudinal extent of the torsion rod. On the first and on the second substrate a first and a second electrical receiving device are arranged and on the third substrate at least part of an electrical transmitting device is arranged, or on the first and on the second substrate at least part of a first and of a second electrical transmitting device are arranged and on the third substrate an electrical receiving device is arranged. The first and second receiving device or the first and second transmitting device are differentially connected to one another.

The invention relates to a sensor arrangement for determining a torsion angle of a torsion bar, in particular a steering device of a motor vehicle, having at least one first, second and third, in particular in each case flat or disc-shaped, substrate, which are spaced apart from one another on the torsion bar and are each connected to the torsion bar in a rotationally fixed manner, whereby the third substrate is arranged between the first substrate and the second substrate in the longitudinal extent of the torsion bar, whereby on the first and on the second substrate, a first and a second electrical receiving device are arranged and on the third substrate at least part of an electrical transmitting device is arranged, or whereby on the first and on the second substrate at least part of a first and of a second electrical transmitting device are arranged and on the third substrate an electrical receiving device is arranged.

The invention further relates to a steering device having such a sensor arrangement, a motor vehicle having such a steering device, and a method for operating such a sensor arrangement.

### PRIOR ART

It is known to determine the torque in inductive torque angle sensors (TAS) or steering angle sensors by the difference between two absolute angle measurements. For this purpose, the absolute angle is determined at two axial positions of a torsion bar. The torque applied to the torsion bar is in good proximity proportional to the difference between these two angles. This measurement principle is, e.g., used in electromechanically supported steering systems in motor vehicles.

In such sensors, two electrically conductive eddy current targets are typically mounted on the torsion bar, which are detected by a measuring board that is decoupled from the rotation of the bar. In this case, the angle of the two targets (due to the periodicity of the design) is electrically detected in relation to the measuring board (absolute angle). The difference between these two angles is proportional to the torque applied to the torsion bar, as described hereinabove. An angular error of this absolute angle measurement thus has a direct effect on the measured torque.

Sensor arrangements are known from the prior art which are intended to increase the measurement accuracy when forming the difference between these angular variables. For example, DE 10 2008 006 865 A1 discloses an inductive torque sensor comprising an exciter coil having a stator circuit board comprising a first and a second receiver means, and having two rotors that can be rotated relative to each other and relative to the stator circuit board, and which influence the strength of an inductive coupling between the exciter coil and the receiver means. The stator circuit board is arranged between the two rotors.

### DISCLOSURE OF THE INVENTION

The sensor arrangement according to the invention having the features of claim 1 is characterized by the first and second receiving devices, or the first and second transmitting devices, being differentially connected to one another. The differential, i.e. electrically opposing, connection creates a particularly advantageous option for determining the torsion angle from a direct measurement of the difference angle of rotation of the receiving devices or the transmitting devices relative to one another, instead of determining the torsion angle from a difference in the absolute rotation angles of a rotation of the respective receiving device relative to the transmitting device, as described hereinabove, which is associated with a higher measurement uncertainty. In this respect, a precise direct measurement of the difference angle by the differentially connected receiving devices or transmitting devices is possible without a detour via two individual absolute angles, the difference of which is only formed in a later step. The differential measurement principle enables the use of a higher amplification factor compared to sensor arrangements known from the prior art because the differential signal is not superimposed by the signal of the absolute angle. As a result, the dynamic range of an application-specific integrated circuit (ASIC) used to demodulate the signal is, e.g., particularly advantageously utilized, thus improving the signal quality by increasing the signal to noise ratio (SNR). Therefore, torque is more advantageously more precisely resolved than the sensor arrangements known from the prior art. The substrates on which the receiving devices and the transmitting devices are arranged are in particular each pushed onto the torsion bar. In particular, the substrates are designed as printed circuit boards. These printed circuit boards are connected to the torsion bar in a rotationally foxed manner, and therefore rotate with it. Particularly preferably, at least one of the substrates, in particular the first and the second substrate, is arranged on a spacer attached to the torsion bar by means of a bracket for raising the torsion lever. In order to increase the safety and monitoring of fault events, it is particularly preferred that the transmitting and receiving devices, which are in particular designed as coils, are designed to be individually measured and monitored by electronic switches of the ASIC at specified time intervals. Further preferably, the sensor arrangement comprises at least one magnetic angle sensor for measuring the absolute torsion angle in order to achieve a particularly advantageous plausibility check of the sensor signals. In order to achieve an advantageous redundancy of the sensor arrangement, the use of at least one of the transmitting and/or receiving devices by a second ASIC circuit is provided in particular.

According to a preferred embodiment of the invention, it is provided that the transmitting device comprises at least one transmitting coil, the first receiving device comprises at least one first receiving coil and the second receiving device comprises at least one second receiving coil, or that the first transmitting device comprises at least one first transmitting coil, the second transmitting device comprises at least one second transmitting coil, and the receiving device comprises at least one receiving coil. The use of transmitting and receiving coils provides a particularly advantageous option for determining the torsion angle using the sensor arrangement according to the invention. For example, a transmitting device coil (TX coil) is arranged on the third substrate, which is designed as a printed circuit board (PCB) in particular. Preferably, the transmitting coil is designed such that a harmonic magnetic field at a specified frequency can be generated or is generated by it, which in particular has a specified periodicity in the angular direction. Further preferably, the transmitting coil is designed such that the distribution of the magnetic field or the strength of the magnetic field is approximately rectangular as a function of the angle and locally radially homogeneous. A change of the magnetic field over time induces an electric voltage in a first receiving coil (RX coil) arranged on the first substrate and a second receiving coil (RX coil) arranged on the second substrate. The two coils are connected differentially, i.e. electrically in opposite directions, and are designed to be demodulated together. If a torque then acts on the shaft (torsion bar), then the change in the voltage difference between the two receiving coils can be used to infer the differential angle between the fastening points of the corresponding substrates on the shaft. Alternatively, instead of two receiving coils, only one receiving coil is provided on the third substrate and a first and a second transmitting coil on the first and second substrate. Preferably, the voltage difference is directly proportional to the torque by suitable choice of coil geometry. The periodicity of the design, in particular the coil geometry, results in the uniqueness range of the measurement method. Particularly preferably, the periodicity of the design is selected such that the maximum differential angle occurring on the torsion bar optimally fills the uniqueness range.

Particularly preferably, it is provided that the first and the second transmitting coil or the first and the second receiving coil each comprise the same number of windings. The robustness of the measurement method is particularly advantageously increased as a result. If more than just two transmitting coils or receiving coils are provided, as will be explained in the following text, it is particularly preferably that they each comprise the same number of windings.

According to a preferred embodiment of the invention, it is provided that the transmitting device comprises an electrically conductive active element, in particular a target, arranged on the third substrate or designed as the third substrate, and a stationary exciter coil associated with the active element. As a result, a particularly advantageous alternative option for determining the torsion angle is provided. An angle-dependent magnetic field is also generated by such an arrangement. Instead of a specially shaped transmitting coil on the third substrate, a non-rotating, i.e. stationary and in particular rotationally symmetric transmitting coil, is provided, which is associated with an electrically conductive active element that rotates with the torsion bar, in particular in the form of a target. The active element is either arranged on the third substrate, or the third substrate is electrically conductive and forms the active element itself. The resulting magnetic field is superposed locally, depending on the angle, by an electromagnetic field generated by eddy currents in the target, such that the torsion angle can be determined as a function of this.

Particularly preferably, it is provided that at least one of the transmitting coils, receiving coils or the active element runs or is designed geometrically and periodically along the respective substrate in the tangential direction. The advantage of such a periodicity is that the coils and the active element are also geometrically differentiated. In particular, one period corresponds to one winding of the coils, which are in particular geometrically sinusoidal.

According to one preferred embodiment of the invention, it is provided that the at least one of the transmitting coils, receiving coils or the active element is sinusoidal or at least approximately stepped, in particular rectangularly, in the tangential direction along the respective substrate. As a result, a geometrically particularly simple way of achieving the periodicity is provided, as described hereinabove.

Particularly preferably, it is provided that the geometry is selected such that the output signals of the transmitting devices and/or receiving devices represent a torsion angle of the torsion bar. The advantage of such a connection is that the torsion angle is determined particularly simply and reliably by the sensor arrangement according to the invention. In particular, a plurality of coils is provided as transmitting device or receiving devices, which are electrically offset from one another by a specified angle. For example, two coils offset by 90° to one another or three coils electrically offset by 120° to one another are provided.

According to a preferred embodiment of the invention, it is provided that an electrical voltage induced in the sensor arrangement is proportional to the torsion angle of the torsion bar. As a result, a particularly advantageous robust way of determining the torsion angle is provided. In particular, the torsion angle is at least approximately proportional to a torsion torque acting on the torsion bar so that the electric voltage induced in the sensor arrangement is also proportional to the torsion torque.

Particularly preferably, it is provided that at least two transmitting devices or receiving devices are arranged on at least one of the substrates, each offset from one another by a specified rotation angle. As a result, the robustness of the measurement method is particularly advantageously increased because redundancy is provided. Preferably, the transmitting devices and/or the receiving devices are each provided in duplicate. For example, not only a first and a second receiving device having a first and a second receiving coils are provided, but in each case two first and two second receiving coils, whereby the two first receiving coils and the two second receiving coils are each arranged offset from one another by a specified angle, preferably electrically by 90°. Particularly advantageously, the coils feature a sinusoidal coil geometry. Using such sinusoidal coils, the torque is proportional to the corrected arc tangent of the ratio of induced voltages in the two coils pairs. Alternatively, the coils feature a rectangular coil geometry. When using such rectangular coil pairs, the reference position of the two coil pairs is preferably selected such that, without torque applied, the differential voltage of the first coil pair is +50% of the full possible amplitude and the differential voltage of the second coil pair is −50%. Particularly preferably, the coils comprising a plurality of windings in order to increase the amplitude of the signal. Preferably, both transmitting or receiving coils comprise the same number of windings.

According to a preferred embodiment of the invention, it is provided that at least one further substrate comprising at least one further transmitting device or receiving device is arranged on the torsion bar in a rotationally fixed manner. As a result, a particularly advantageous redundancy is provided in the event of failure of one of the transmitting devices or the receiving devices. Particularly preferably, the respective transmitting device or receiving device is arranged offset from at least one of the other transmitting devices or receiving devices by a specified rotation angle, as described hereinabove. Alternatively, they feature the same angular alignment, so they are not arranged at an angular offset.

Particularly preferably, it is provided that the torsion bar has an electrically conductive material and forms a ground connection for at least one of the transmitting devices or the receiving devices. The design of the ground connection through the torsion bar results in the advantage that there is no need for a separate ground connection because the transmitting device and receiving device are already electrically conductively connected to it due to the rotationally fixed connection of the substrates of the torsion bar.

According to a preferred embodiment of the invention, it is provided that the energy and/or signal transmission to at least one of the transmitting devices or the receiving devices is performed by flex cables, sliding contacts, or wirelessly. Such electrical contacting of the transmitting device and/or receiving devices creates a particularly advantageous option for efficient energy and/or signal transmission.

The steering device of a motor vehicle having the features of claim 13 comprises the sensor arrangement according to the invention. This, too, results in the advantages specified hereinabove.

The motor vehicle having the features of claim 14 comprises the steering device according to the invention. The advantages specified hereinabove are achieved as a result.

The method for operating the sensor arrangement according to the invention is characterized by the features of claim 15 by a differential angle of a rotation of the receiving devices or the transmitting relative to one another being determined as a function of a voltage difference of an induced electrical voltage. Such a measurement method has a particularly advantageous high measurement accuracy due to the advantages of the sensor arrangement according to the invention described hereinabove.

Further preferred features and combinations of features result from what was previously described and from the claims. The invention is explained in more detail below with reference to the drawings. Shown are:

FIG. 1 an advantageous sensor arrangement,

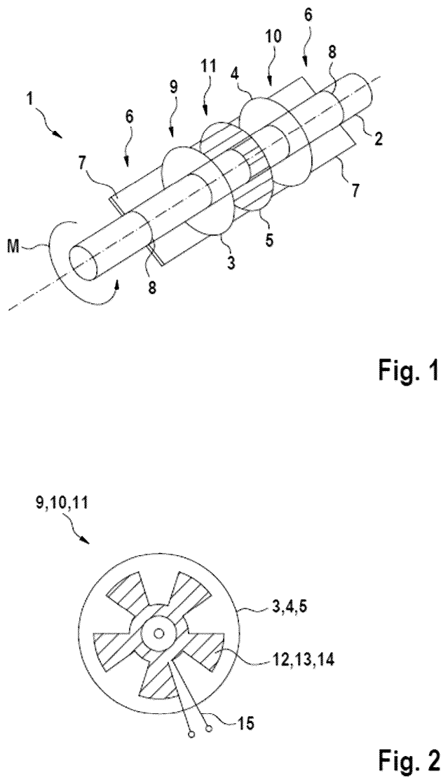

FIG. 2 a first exemplary embodiment of a transmitting device or receiving device for the sensor arrangement,

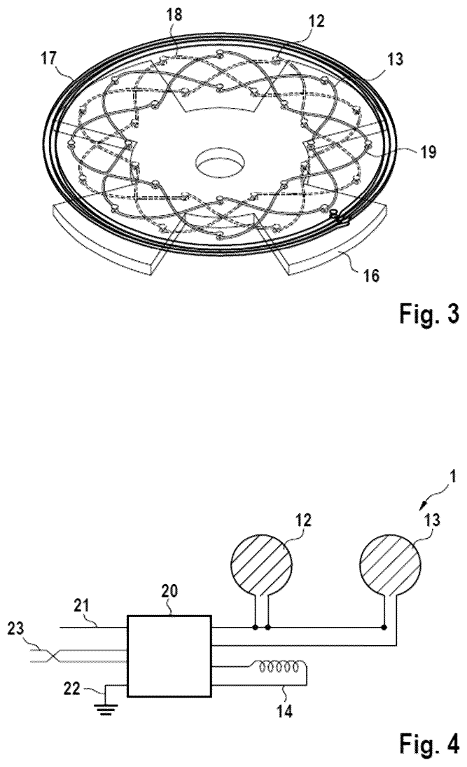

FIG. 3 a second exemplary embodiment of a transmitting device or receiving device for the sensor arrangement,

FIG. 4 a diagram of a transmitting or receiving device for the sensor arrangement,

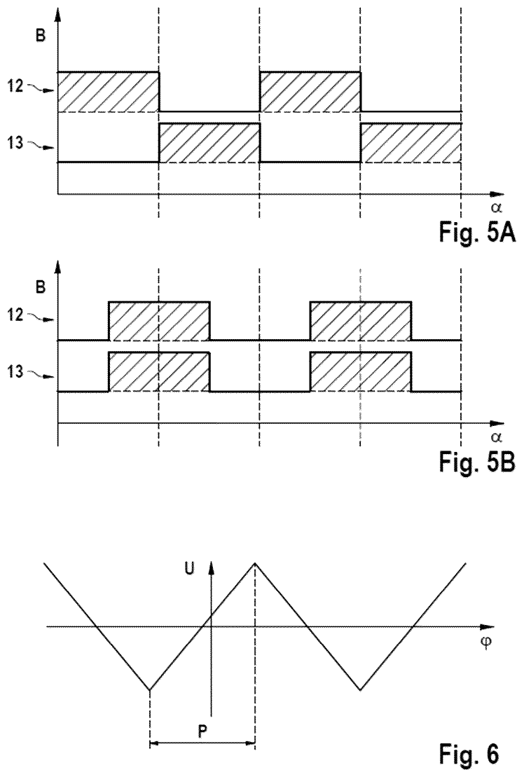

FIGS. 5A and 5B magnetic field angle plots when using the sensor assembly, and

FIG. 6 a voltage-angle plot.

FIG. 1 shows a sensor arrangement 1 for determining a torsion angle or torque M of a torsion bar 2, as indicated by a circular arrow. The torsion bar 2 is in particular part of a steering device of a motor vehicle (not shown). The sensor arrangement 1 comprises a first substrate 3, a second substrate 4, and a third substrate 5. The substrates 3, 4, 5 are designed as disc-shaped printed circuit boards in the present case, by way of example only. The substrates 3, 4, 5 are arranged spaced apart from one another on the torsion bar 2 and are connected to the torsion bar 2 in a rotationally fixed manner.

In the present case, the first substrate 3 and the second substrate 4 are each connected to the torsion bar 2 in a rotationally fixed manner by a holding device 6, comprising a bracket 7 and a spacer 8 attached to the torsion bar 2. The (mirror image) holding devices 6 are used to increase the torsion lever, i.e. the detected torsion angle.

The third substrate 5 is arranged between the first substrate 3 and the second substrate 4 in the longitudinal extent of the torsion bar 2. At least parts of electrical receiving devices or transmitting devices are arranged on the substrates 3, 4, 5. For reasons of clarity, these are not shown in detail in FIG. 1.

For the arrangement of the receiving devices and the transmitting devices on the substrates 3, 4, 5, there are different options. Thus, either a first and a second electrical receiving device are arranged on the first substrate 3 and on the second substrate 4, and at least part of an electrical transmitting device is arranged on the third substrate 5, or at least part of a first and a second electrical transmitting device is arranged on the first substrate 3 and on the second substrate 4, and an electrical receiving device is arranged on the third substrate 5.

At least two receiving devices and/or two transmitting device devices are therefore provided. According to the invention, the first and the second receiving device or the first and the second transmitting device are differentially electrically connected to one another. This will be further explained with reference to FIG. 4.

A first, specific option for the arrangement and design of the transmitting and receiving device is that a first receiving device 9 comprising a first receiving coil is arranged on the first substrate 3, a second receiving device 10 comprising a second receiving coil is arranged on the second substrate 4, and a transmitting device 11 comprising a transmitting coil is arranged on the third substrate 5.

Alternatively, the roles of the transmitting and receiving devices are reversed according to a second option, i.e. a first transmitting device 9′ comprising a first transmitting coil is arranged on the first substrate 3, a second transmitting device 10′ comprising a second transmitting device coil is arranged on the second substrate 4, and a receiving device 11′ comprising a receiving coil is arranged on the third substrate 5. For reasons of clarity, this option is not indicated in the drawings by the corresponding reference characters.

In a third option, instead of the transmitting device 11 comprising the transmitting coil on the third substrate 5, only an electrically conductive active element, which is particularly designed as a target, is arranged as part of the transmitting device 11 or is formed by the third substrate 5. A stationary exciter coil is then associated with the active element.

These options will be described hereinafter with reference to FIGS. 2 and 3 as different exemplary embodiments.

Thus, FIG. 2 shows a first exemplary embodiment of such transmitting or receiving devices 9, 10, 11 (or 9′, 10′, 11′) for the sensor arrangement 1. In this embodiment, the transmitting and receiving devices 9, 10, 11 each comprises at least one coil, as described hereinabove (options 1 and 2). The corresponding arrangements are preferably identical or at least similarly designed so that FIG. 2 shows an exemplary embodiment for each of the substrates 3, 4, 5 comprising the transmitting and receiving devices 9, 10, 11.

In the present case, the first receiving device 9 comprises a first receiving coil 12, the second receiving device 10 comprises a second receiving coil 13, and the transmitting device 11 comprises a transmitting coil 14. The coils 12, 13, 14 extend geometrically and periodically along the respective substrate 3, 4, 5 in the tangential direction. For this purpose, they are designed to be stepped in the tangential direction, in the present case rectangularly. The energy and/or signal transmission to or from the various coils 12, 13, 14 is performed by electrical contact terminals 15. These are in particular designed as flex cables or sliding contacts.

Corresponding coils 12′, 13′, 14′ are provided for using the transmitting or receiving devices 9′, 10′, 11′, The first transmitting device 9′ then comprises a first transmitting coil 12′, the second transmitting device 10 comprises a second transmitting coil 13′, and the receiving device 11′ comprises a receiving coil 14′. For reasons of clarity, this option is not indicated in the drawings by the corresponding reference characters.

FIG. 3 shows a second exemplary embodiment of such transmitting or receiving devices 9, 10, 11 for the sensor arrangement 1. Instead of the transmitting coil 14, an electrically conductive active element 16, designed as a target, is arranged on the third substrate 5, with which a stationary exciter coil 17 comprising a plurality of windings is associated. The first receiving coil 12 and the second receiving coil 13 continue to extend geometrically and periodically along the respective substrate 3, 4 in the tangential direction, but are then sinusoidal in the tangential direction in contrast to the previous exemplary embodiment, and thus already inherently differential. In the sensor arrangement 1 according to the invention, these differential coils are then differentially connected in series in pairs, as will be explained with reference to FIG. 4.

To increase the robustness of the measurement method, a further first receiving coil 18 and a further second receiving coil 19 are provided in each case, whereby the first receiving coils 12, 18 and the second receiving coils 13, 19 are arranged offset from one another in each case. The corresponding substrates 3, 4, 5 are not shown or are shown as transparent for reasons of clarity. Alternatively, the active element 16 forms the third substrate 5 directly.

FIG. 4 shows an exemplary diagram of a combination of two of the transmitting or receiving devices 9, 10, 11 for the sensor arrangement 1. By way of example, the connection of the two receiving coils 12, 13 on the first and second substrates 3, 4 is shown. These are differentially connected to one another via a circuit arrangement 20 shown as a block, in particular in the form of an ASIC, meaning that electrical current passes through them in opposite directions. The transmitting coil 14 is also connected to the circuit arrangement 20.

The circuit arrangement 20 is supplied with electrical voltage via a supply line 21 and is connected to an electrical reference potential via the ground line 22. An output signal of the sensor arrangement 1 is output via output lines 23.

FIGS. 5A and 5B show magnetic field angle diagrams when using the sensor arrangement 1, in the present case a progression of the magnetic field strength of a magnetic field B over a torsion angle a. Thus, FIG. 5A shows the amount of the magnetic field B that arises when the torsion bar 2 is torsioned if the first receiving coil 12 and the second receiving coil 13 are at an angular offset of 90° to each other.

In this arrangement, there are always alternating regions with maximum signals for each of the coils 12, 13, represented by the correspondingly shaded areas representing the strength of the magnetic field B, so that a maximum possible total signal is produced as the output signal of the sensor arrangement 1.

FIG. 5B shows the amount of the magnetic field B that arises when the torsion bar 2 is torsioned if the coils 12, 13 are not at an angular offset to each other. Accordingly, the regions with maximum and minimum magnetic field strength are congruent so that a minimum possible total signal is output.

Finally, FIG. 6 shows a voltage-angle plot, in the present case a progression of the induced electrical voltage U in the receiving coils 12, 13 over their differential angle φ. It can be seen that the voltage signal repeats at a periodicity P, so that a uniqueness range is defined thereby. The receiving coils 12, 13 are in this case geometrically designed such that the induced voltage is proportional to the torsion angle and the torsional torque on the torsion bar 2.

1. A sensor arrangement for determining a torsion angle of a torsion bar having at least a first substrate, a second substrate, and a third substrate, which are spaced apart from one another on the torsion bar and are each connected to the torsion bar in a rotationally fixed manner, wherein:
the third substrate is arranged between the first substrate and the second substrate in the longitudinal extent of the torsion bar,
on the first substrate and on the second substrate, (i) a first and a second electrical receiving device are arranged, and on the third substrate at least part of an electrical transmitting device is arranged, or (ii) at least part of a first and of a second electrical transmitting device are arranged, and on the third substrate an electrical receiving device is arranged, and
the first and the second receiving device or the first and the second transmitting device are differently connected to one another.

2. The sensor arrangement according to claim 1, wherein the transmitting device comprises at least one transmitting device coil, the first receiving device comprises at least one first receiving coil, and the second receiving device comprises at least one second receiving coil, or the first transmitting device comprises at least one first transmitting device coil, the second transmitting device comprises at least one second transmitting device coil, and the receiving device comprises at least one receiving coil.

3. The sensor arrangement according to claim 2, wherein the first and the second transmitting coil or the first and the second receiving coil each comprise the same number of windings.

4. The sensor arrangement according to claim 1, wherein the transmitting device comprises an electrically conductive active element which is arranged on the third substrate or forms the third substrate, and a stationary exciter coil associated with the active element.

5. The sensor arrangement according to claim 2, wherein at least one of the transmitting coils, receiving coils or the active element extends or is designed geometrically and periodically along the respective substrate in the tangential direction.

6. The sensor arrangement according to claim 5, wherein the at least one of the transmitting coils, the receiving coils, or the active element extends or is designed in the tangential direction sinusoidally or at least approximately stepped, along the respective substrate.

7. The sensor arrangement according to claim 1, wherein the geometry is selected such that the output signals of the transmitting devices and/or the receiving devices represent a torsion angle of the torsion bar.

8. The sensor arrangement according to claim 7, wherein an electrical voltage induced in the sensor arrangement is proportional to the torsion angle of the torsion bar.

9. The sensor arrangement according to claim 7, wherein at least two transmitting devices or receiving devices are arranged on at least one of the substrates each offset from one another by a specified rotation angle.

10. The sensor arrangement according to claim 1, further comprising at least one further substrate comprising at least one further transmitting device or receiving device that is arranged on the torsion bar in a rotationally fixed manner.

11. The sensor arrangement according to claim 1, wherein the torsion bar comprises an electrically conductive material and forms a ground connection for at least one of the transmitting devices or the receiving devices.

12. The sensor arrangement according to claim 1, wherein the energy and/or signal transmission to at least one of the transmitting devices or the receiving devices is performed by flex cables, sliding contacts, or wirelessly.

13. A steering device of a motor vehicle, comprising a sensor arrangement according to claim 1.

14. A motor vehicle, comprising a steering device according to claim 13.

15. A method for operating a sensor arrangement according to claim 1, wherein a differential angle of a rotation of the receiving device or the transmitting device relative to one another is determined as a function of a voltage difference of an induced electric voltage.

16. The sensor arrangement according to claim 1, wherein the torsion bar includes a steering device of a motor vehicle.

17. The sensor arrangement according to claim 1, wherein the first substrate, the second substrate, and the third substrate each are flat or disc-shaped.

18. The sensor arrangement according to claim 4, wherein the electrically conductive active element includes a target.
